(19) United States
(12) Patent Application Publication
(10) Pub. No.: US 2022/0036191 A1
(43) Pub. Date: Feb. 3, 2022

(54) System and Related Methods for Reducing the Resource Consumption of a Convolutional Neural Network

(71) Applicant: Google LLC, Mountain View, CA (US)

(72) Inventors: Yair Movshovitz-Attias, Mountain View, CA (US); Andrew Poon, Mountain View, CA (US); Ariel Gordon, Mountain View, CA (US); Elad Edwin Tzvi Eban, Sunnyvale, CA (US)

(21) Appl. No.: 17/298,853

(22) PCT Filed: Jan. 10, 2019
(86) PCT No.: PCT/US2019/013034

§ 371 Date: Jun. 1, 2021

Related U.S. Application Data
(60) Provisional application No. 62/772,654, filed on Nov. 29, 2018.

(51) Int. Cl. G06N 3/08; G06N 20/10

(52) U.S. Cl. CPC G06N 3/082; G06N 20/10

(57) ABSTRACT

A computer-implemented method for reducing the resource consumption of a convolutional neural network can include obtaining data descriptive of the convolutional neural network. The convolutional neural network can include a plurality of convolutional layers configured to perform convolutions using a plurality of kernels that each includes a plurality of kernel elements. The method can include training, for one or more training iterations, the convolutional neural network using a loss function that includes a group sparsifying regularizer term configured to sparsify a respective subset of the kernel elements of the kernel(s); following at least one training iteration, determining, for each of the kernel(s), whether to modify such kernel to remove the respective subset of the kernel elements based at least in part on respective values of the respective subset of kernel elements; and modifying at least one of the kernel(s) to remove the respective subset of the kernel elements.

The present disclosure relates generally to convolutional neural networks. More particularly, the present disclosure relates to systems and related methods for reducing the resource consumption of a convolutional neural network.

### BACKGROUND

Convolutional neural networks generally include convolutional layers that apply learned kernels (also referred to as filters) to perform convolutions over respective input data to produce respective output data. For many existing convolutional neural networks, the respective sizes (e.g., dimensions) of the various kernels are manually selected by a human to balance performance with computational demand. For example, in some instances, larger kernels can provide greater accuracy and/or better performance. However, increased kernel size generally results in greater computational demand, which can increase the time required to execute the model. For example, a larger kernel will include a greater number of parameters. Each separate parameter value of the network is typically stored in memory and, therefore, larger kernels will result in the network consuming additional memory resources when stored on a device. As another example, when the network is implemented to generate inferences, a larger kernel will require additional processing operations (e.g., floating point operations or FLOP) and, therefore, larger kernels will result in the network consuming additional processing resources and/or having increased latency when implemented on a device. Increased consumption of resources such as memory resources and/or processor resources is generally undesirable and can be particularly problematic if the network is stored and/or implemented in a resource-constrained environment such as a mobile device, an embedded device, and/or an edge device.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for reducing the resource consumption of a convolutional neural network. The method can include obtaining, by one or more computing devices, data descriptive of the convolutional neural network. The convolutional neural network can include a plurality of convolutional layers configured to perform convolutions using a plurality of kernels. Each of the plurality of kernels can include a plurality of kernel elements. The method can include training, by the one or more computing devices for one or more training iterations, the convolutional neural network using a loss function that comprises a group sparsifying regularizer term. The group sparsifying regularizer term can be configured to sparsify a respective subset of the kernel elements of each of one or more kernels of the plurality of kernels of the convolutional neural network. The method can include, following at least one training iteration, determining, by the one or more computing devices, for each of the one or more kernels, whether to modify such kernel to remove the respective subset of the kernel elements based at least in part on respective values of the respective subset of kernel elements associated with such kernel. The method can include modifying, by the one or more computing devices, at least one of the one or more kernels to remove the respective subset of the kernel elements.

Another example aspect of the present disclosure is directed to a computing system that can include one or more processors and a machine-learned model. The machine-learned model can include a convolutional neural network that includes a plurality of convolutional layers including a plurality of kernels. The machine-learned model can be configured to receive a model input, and, in response to receipt of the model input, output a model output. The computing system can include one or more non-transitory computer-readable media that collectively store instructions that, when executed by the one or more processors, cause the computing system to perform operations. The operations can include obtaining data descriptive of the convolutional neural network. The convolutional neural network can include a plurality of convolutional layers configured to perform convolutions using a plurality of kernels. Each of the plurality of kernels can include a plurality of kernel elements. The operations can include training, for one or more training iterations, the convolutional neural network using a loss function that comprises a group sparsifying regularizer term configured to sparsify a respective subset of the kernel elements of each of one or more kernels of the plurality of kernels of the convolutional neural network. The operations can include following at least one training iteration, determining for each of the one or more kernels, whether to modify a respective size of such kernel to remove the respective subset of the kernel elements based at least in part on respective values of the respective subset of kernel elements associated with such kernel. The operations can include modifying the respective size of at least one of the one or more kernels to remove the respective subset of the kernel elements.

Another example aspect of the present disclosure is directed to a computing system that can include one or more processors and one or more non-transitory computer-readable media that collectively store instructions that, when executed by the one or more processors, cause the computing system to perform operations. The operations can include receiving a machine-learned model that includes a convolutional neural network. The convolutional neural network can include a plurality of convolutional layers configured to perform convolutions using a plurality of kernels. Each of the plurality of kernels can include a plurality of kernel elements. The operations can include determining, by the one or more computing devices, for at least one of the plurality of kernels, whether to modify a respective size of the at least one of the plurality of kernels to remove the respective subset of the kernel elements based at least in part on respective values of the respective subset of kernel elements associated with such kernel. The operations can include modifying, by the one or more computing devices, the respective size of at least one of the one or more kernels to remove the respective subset of the kernel elements.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system according to example embodiments of the present disclosure.

FIG. 1B depicts a block diagram of an example computing system according to example embodiments of the present disclosure.

FIG. 1C depicts a block diagram of an example computing system according to example embodiments of the present disclosure.

FIG. 2A depicts an example kernel before and after modification to remove a subset of kernel elements according to example embodiments of the present disclosure.

FIG. 2B depicts another example kernel before and after modification to remove a subset of kernel elements according to example embodiments of the present disclosure.

FIG. 3A depicts a graphical diagram of example standard convolutional filters according to example embodiments of the present disclosure.

FIG. 3B depicts a graphical diagram of example depthwise convolutional filters according to example embodiments of the present disclosure.

FIG. 3C depicts a graphical diagram of example pointwise convolutional filters according to example embodiments of the present disclosure.

FIG. 4 depicts a flow chart diagram of an example method for reducing the resource consumption of a convolutional neural network according to example embodiments of the present disclosure.

FIG. 5 depicts a flow chart diagram of another example method for reducing the resource consumption of a convolutional neural network according to example embodiments of the present disclosure.

FIG. 6 is a chart of accuracy measurements for various example tests of machine-learned models, including “fk_1e-3” and “fk_1e-4,” models representing results from machine-learned models that were modified according to example embodiments of the present disclosure.

FIG. 7 is a chart of an average ratio of an L2 norm of a subset of kernel elements arranged around an exterior edge of a kernel to an L2 norm of an inner set of kernel elements that are not exposed along the exterior edge of the kernel for select kernels within sequential layers of a convolutional neural network according to example embodiments of the present disclosure.

FIG. 8 depicts an average of kernel element values over an absolute value of an input depth for select kernels within sequential layers of a convolutional neural network modified using a first regularization factor according to example embodiments of the present disclosure.

FIG. 9 depicts an average of kernel element values over an absolute value of an input depth for select kernels within sequential layers of a convolutional neural network modified using a second regularization factor according to example embodiments of the present disclosure.

Reference numerals that are repeated across plural figures are intended to identify the same features in various implementations.

### DETAILED DESCRIPTION

### Overview

Generally, the present disclosure is directed to computing systems and related methods for reducing the resource consumption of a convolutional neural network. The systems and related methods described herein can determine and/or adjust the size or other characteristics of kernels in a convolutional neural network in an intelligent or learned way. In particular, according to an aspect of the present disclosure, a computing system can train a convolutional neural network using a loss function that includes a group sparsifying regularizer term that is configured to sparsify a respective subset of the kernel elements of each of one or more kernels included in the convolutional neural network. In one example, the subset of the kernel elements can be elements that are arranged around an outer edge of the kernel. Thus, through application and operation of the group sparsifying regularizer term, subset(s) of kernel elements that are not significantly contributing to the operation of their respective kernels can be sparsified (e.g., regularized to sparsity). After regularizing respective subsets of kernel elements of the one or more kernels included in the convolutional neural network, an analysis can be performed to determine whether to modify each kernel to remove the respective subset of the kernel elements (e.g., by modifying a size of the kernel). For example, a ratio of a norm of the values of the subset of kernel elements to a norm of the values of kernel elements not included in the subset can be compared to a threshold value and, if the ratio is less than the threshold, the subset of kernel elements can be removed from the kernel. In some implementations in which the subset of kernel elements are arranged around an outer edge of the kernel, removal of the subset of kernel elements can result in the kernel being resized. As one example, a 5×5 kernel can be changed to a 3×3 kernel. The kernels can be modified before or during training of the model. As a result of removing the subset of kernel elements, the modified convolutional neural network has fewer parameters and therefore requires less storage space and/or requires less computational resources. However, because the kernel elements that are removed are those that were regularized to sparsity, their removal does not substantially adversely affect performance of the model. Further, in some instances, aspects of the present disclosure can improve performance of the model by reducing overfitting.

According to aspects of the present disclosure, a computing system can reduce the resource consumption of a convolutional neural network. In particular, a computing system can obtain data descriptive of a convolutional neural network that includes a plurality of convolutional layers configured to perform convolutions using a plurality of kernels. Each of the plurality of kernels can include a plurality of kernel elements. The data can include information about the structure of the convolutional neural network, sizes of the various layers and/or kernels, and/or connections between the various layers and/or kernels.

As one example, a computing system according to aspects of the present disclosure can be provided to users as a service, for example, within a suite of tools and/or applications. Users can access the computing system through a web-based interface and/or application program interface. The computing system can be configured to train and/or modify machine-learned models for the users. The users can upload their own machine-learned models to the computing system or start with pre-existing machine-learned models stored by the computing system. The users can control or direct training or modification of the machine-learned model as described herein. The users can modify one or more control parameters (e.g., the threshold ratio of norm values) or otherwise control aspects of the systems and methods described herein. The users can define and/or modify the subset of kernel elements, the group sparsifying regularizer term, or other aspects of the system and methods.

The computing system can train the convolutional neural network for one or more training iterations using a loss function that includes a group sparsifying regularizer term configured to sparsify a respective subset of the kernel elements of the convolutional neural network.

The subset(s) of kernel elements on which the group sparsifying regularizer term operates can be arranged in a variety of configurations within the kernels. Each subset may comprise a plurality of kernel elements. The kernel elements of a subset may have a defined positional relationship within the kernel. As one example, the subset of kernel elements for a given kernel can be arranged around an exterior edge of the kernel, for example, forming a border around the kernel. Thus, in some examples, the subset of kernel elements can form a contiguous shape (e.g., a border) within the kernel.

In other implementations, however, the subset of kernel elements can form one or more non-contiguous shapes within a given kernel. For example, the subset of kernel elements can include vertical stripes of elements, horizontal stripes of elements, grids of elements, and/or other arrangements of kernel elements. Thus, at least some of the subset of kernel elements can be dispersed within the kernel (e.g., not limited to kernel elements arranged along the exterior edge of the kernel). Elements within the subset can be adjacent and/or non-adjacent to each other. In some implementations, removal of subsets of kernel elements according to certain arrangements can result in a diluted or “Atruos” kernel. However, the subset of kernel elements can have any suitable shape.

In some implementations, the subset of kernel elements can be selected by or based in part on user input (e.g., a user input that selects the elements along the exterior edge of the kernel). In some implementations, the subset of kernel elements can be randomly selected. In some implementations, the subset of kernel elements can be selected according to their current values (e.g., a certain number or percentage of the kernel elements with the smallest values can be selected for inclusion in the subset of kernel elements that are regularized).

In some implementations, a single subset of kernel elements is selected for each of one or more kernels. As another example, multiple subsets may be defined within a given kernel, and the group sparsifying regularizer can operate to separately sparsify the multiple subsets of kernel elements within the kernel. As one example, a first subset can be defined along the exterior edge of the kernel (e.g., the outer boundary of kernel elements). A second subset can be defined as kernel elements adjacent the first subset but not exposed along the exterior edge (e.g., a square or ring-shaped set of elements). Thus, concentric rings of kernel elements can be defined as different subsets within the kernel.

The group sparsifying regularizer term of the loss function can generally be configured to sparsify the respective subset of the kernel elements in a given kernel. The group sparsifying regularizer term can provide a loss penalty that is positively correlated to a magnitude of the values of the subset of kernel elements. As one example, the group sparsifying regularizer term can include a norm of the respective values of the respective subset of kernel elements, such as an L2 norm. The values of the subset of kernel elements can be treated as a one-dimensional vector, and the L2 norm (e.g., group lasso) of the one-dimensional vector can be calculated. Other example norms include an L1 norm and an absolute-value norm. Any suitable norm can be used, however.

As another example, the group sparsifying regularizer term can include a learned scaling parameter (e.g., one respective scaling parameter for each subset of kernel elements). For example, a learned parameter can be scaled by a known function, such as an absolute value, the exponential function, the sigmoid function, etc. The values of the subset of kernel elements can be a function of the resulting learned scaling parameter. As a result, each element of in the subset of kernel elements can have a magnitude that is based in part on the learned scaling parameter. Thus, in one example, each kernel element included in a given subset of kernel elements can have the form ∝ kᵢ, where ∝ is the scaling parameter and kᵢ is a scaled value for the ith element of the subset. The group sparsifying regularizer term can provide a penalty that is based on the magnitude of the scaling parameter ∝. For example, the sparsifying regularizer term can operate on the absolute value of the scaling parameter ∝ or a function of the scaling parameter ∝ such as exp(∝), sigmoid(∝), or the like). In such fashion, the group sparsifying regularizer term can push the magnitude of the scaling parameter ∝ towards zero, thereby also sparsifying the values of the subset of kernel elements which are a function of the scaling parameter ∝.

Following at least one training iteration that includes application of the group sparsifying regularizer term to each subset of kernel elements, an analysis can be performed to determine whether to modify one or more of the kernels (e.g., modify a size of the kernel) to remove the respective subset of kernel elements from the kernel. For example, this determination can be performed after training is complete (e.g., after all training iterations have been performed) or during training (e.g., after less than all training iterations have been performed).

Modifying the kernel(s) can include removing a subset of kernel elements based at least in part on respective values of the respective subset of kernel elements. Kernel elements can be selected for removal based on having relatively low values, for example, compared to other kernel elements (e.g., within the same kernel). Modifying kernels as described herein can reduce the computational demand at inference time without substantially adversely affecting the performance of the convolutional neural network.

In some implementations, determining whether to modify the size(s) of the kernel(s) can include comparing the values of the subset of kernel elements to another set of kernel elements (e.g., within the same kernel). More specifically, a ratio can be computed of a first norm of the values of the subset of the kernel elements to a second norm of the values of at least some of the plurality of kernel elements of the respective kernel that are not included in the respective subset of the kernel elements. When the ratio is less than a threshold, the subset of kernel elements can be removed to modify the size of the kernel. The threshold can be selected such that the subset of kernel elements has sufficiently small values and provides a relatively small contribution to the effect of the kernel. In other words, the threshold can be selected such that the removing the subset of the kernels does not substantially adversely affect the performance of the convolutional neural network. In some implementations, the threshold can be dynamic and change over time as the network is trained.

The computing system can modify the size of at least one of the kernels to remove the subset of the kernel elements. As one example, the size of at least one of the plurality of kernels can be n×n, wherein n is an integer greater than 1 (e.g., 3×3, 5×5, 7×7, etc.). Modifying a given kernel can include reducing the size of the kernel to at least n−1×n−1 (e.g., 4×4, 3×3, 2×2, or 1×1).

As one example, a first subset of kernel elements can be defined along the exterior edge of the kernel (e.g., the outer boundary of kernel elements). A second subset can be defined as kernel elements adjacent the first subset but not exposed along the exterior edge (e.g., a square or ring-shaped set of elements). An inner set can be defined as kernel elements not contained within either the first subset of kernel elements or the second subset of kernel elements. The computing system can be configured to remove one or both of the first and second subsets based on respective values of the kernel elements within each subset. For instance, a 7×7 kernel could be modified to be a 5×5 kernel by removing the first subset. The 7×7 kernel could be modified to be a 3×3 kernel by removing the first and second subsets. Such determinations can be based on a ratio of respective norms of the first and/or second subsets to a norm of the inner subset, for example as described below.

In some implementations, the convolutional neural network can include one or more kernels that have multiple depth positions. A first kernel can have a plurality of depth positions and, at least for the first kernel, the group sparsifying regularizer term can be configured to separately sparsify the respective subset of kernel elements at each of the plurality of depth positions. Determining whether to modify the respective size of the first kernel can include separately determining whether to modify the respective size of the first kernel at each of the plurality of depth positions.

In some implementations, the size of the kernel can be modified independently at each depth position. In other words, kernel elements can be removed from a first depth position. Corresponding elements of a second depth position of the kernel may not necessarily be removed. In some instances, the resulting kernel can require additional re-structuring into two or more kernels having the same shape and/or size prior to the inference time.

However, in some implementations, the group sparsifying regularizer term can be configured to collectively sparsify the respective subset of kernel elements (at least for one kernel) at each of the plurality of depth positions as a single group. More specifically, subsets of kernel elements can be respectively defined at each depth position. The respective subsets can have the same arrangement and configuration such that, once removed, the modified kernel has a uniform size and/or shape across the plurality of depth positions. For instance, for each depth position of a given kernel, the subset of kernel elements can be defined as the kernel elements that are arranged along the edge of the kernel at each depth position (e.g., forming a boundary of the kernel element). If such subsets are removed, the resulting modified kernel can have a uniform shape across the plurality of depth positions.

In some implementations, one or more kernels can be modified to increase a dimensional size of the kernel(s) prior to modifying the kernel(s) to remove subset(s) of kernel elements, for example as part of cycle of enlarging and “shrinking” the kernel(s). Some or all kernels of the convolutional neural network can be enlarged (e.g., resized from a 3×3 to a 5×5 kernel). For instance, all kernels can be enlarged (e.g., uniformly or by varying amounts) or only some kernels can be enlarged (e.g., a random selection of layers or kernels can be arbitrarily enlarged). A group sparsifying regularizer term can operate on a subset of kernel elements, as described above, which can result in the kernel being modified to remove the subset (e.g., to “shrink” one or more kernels). The above process of enlarging and shrinking kernels can be repeated such that sizes or configurations of the kernels can be intelligently selected (e.g., to determine optimal sizes or configurations of the kernels and/or improve the configuration of the kernel(s)). Thus, in some implementations, the computing system may be configured to increase the size(s) of one or more kernels, which may improve performance.

Yet another aspect of the present disclosure is directed to another computing system for reducing the resource consumption of a convolutional neural network. The computing system can be configured to modify a machine-learned model that includes a convolutional neural network. Such computing system can be configured to modify the machine-learned model without necessarily performing any training of the machine-learned model. The computing system can receive the machine-learned model including the convolutional neural network, for example, after the machine-learned model has been trained. The convolutional neural network can include a plurality of convolutional layers configured to perform convolutions using a plurality of kernels, and each of the plurality of kernels can include a plurality of kernel elements. The computing system can be configured to determine, for each of the one or more kernels, whether to modify a respective size of the kernel to remove the respective subset of the kernel elements based at least in part on respective values of the respective subset of kernel elements associated with the kernel, for example as described above. The computing system can be configured to modify the respective size of at least one of the one or more kernels to remove the respective subset of the kernel elements. Thus, in at least some implementations, modification of the convolutional neural network can be performed after training of the model has been completed. In other words, at least some aspects of the present disclosure do not involve or require performing any training of the machine-learned model.

Aspects of the present disclosure can find application with any machine-learned model that includes a convolutional neural network. Example applications include categorizing, labeling, or otherwise analyzing “structured data.” Structured data can refer to any data set for which the data exhibits a particular structure or organization that can be leveraged to analyze the data. Examples of structured data include images, video, sound, text, etc. Thus, the systems and methods disclosed herein can be applied to object recognition models that are configured to categorize or label objects depicted in images or video. The systems and methods disclosed herein can also be applied to audio analysis models that are configured to categorize or label sounds contained or represented in audio (e.g., by performing convolutions over the audio). The systems and methods disclosed herein can also be applied to text analysis models (e.g., that are configured to categorize or label textual content contained or represented in text data (e.g., by performing convolutions over the text data). Aspects of the disclosure may therefore comprise utilizing the convolutional neural network as a classifier after modification of the at least one of the at least one or more kernels. For example, aspects may comprise utilizing the convolutional neural network to classify one or more of: image, video, and audio data. The convolutional neural network may be used to classify sensor data in order to improve interpretation of one or more external elements. The classification may be utilized to control a decision-making process.

The systems and methods of the present disclosure provide a number of technical effects and benefits. The systems and methods described herein can reduce required the computational demand and/or storage space with a minimal reduction in performance. By modifying (e.g., downsizing) one or more kernels of the machine-learned model according to aspects of the present disclosure, the size of the model is reduced. As result, the model can more easily be transmitted to and/or stored on device having limited resources (e.g., mobile devices). Reducing the computational demand at inference time associated with executing the machine-learned model can provide better performance per unit of resources consumed. As such, aspects of the present disclosure can improve accessibility and effectivity of machine-learned models including convolutional neural networks, for example, when cloud computing is unavailable or otherwise undesirable (e.g., for reasons of improving user privacy and/or reducing communication cost). Moreover, not only may be the model be more readily executed on devices having limited resources (e.g. mobile devices) but may be done so at a reduced cost in terms of power consumption. This may be of particular significance in devices having limited battery capacity, such as mobile devices.

As one example, the systems and methods of the present disclosure can be included or otherwise employed within the context of an application, a browser plug-in, or in other contexts. Thus, in some implementations, the models of the present disclosure can be included in or otherwise stored and implemented by a user computing device such as a laptop, tablet, or smartphone. As yet another example, the models can be included in or otherwise stored and implemented by a server computing device that communicates with the user computing device according to a client-server relationship. For example, the models can be implemented by the server computing device as a portion of a web service (e.g., a web email service).

With reference now to the Figures, example embodiments of the present disclosure will be discussed in further detail.

### Example Devices and Systems

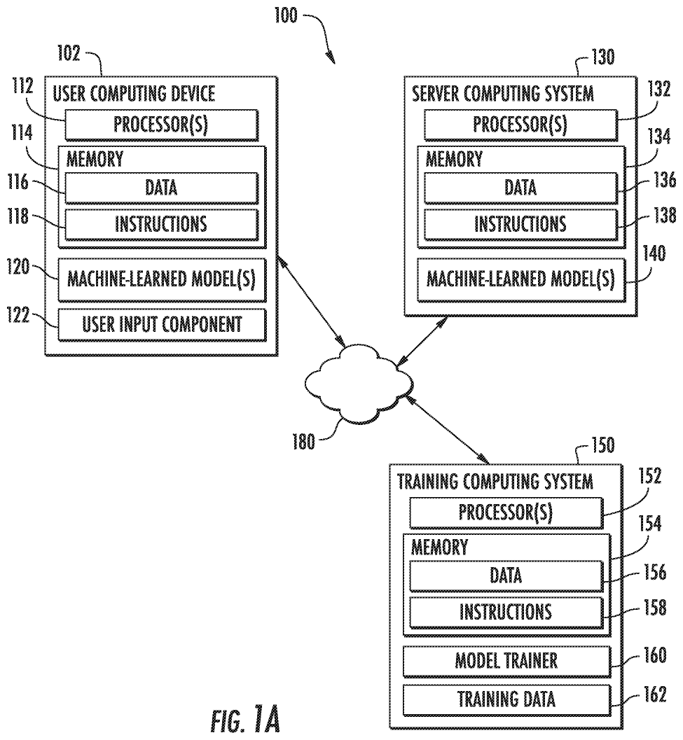

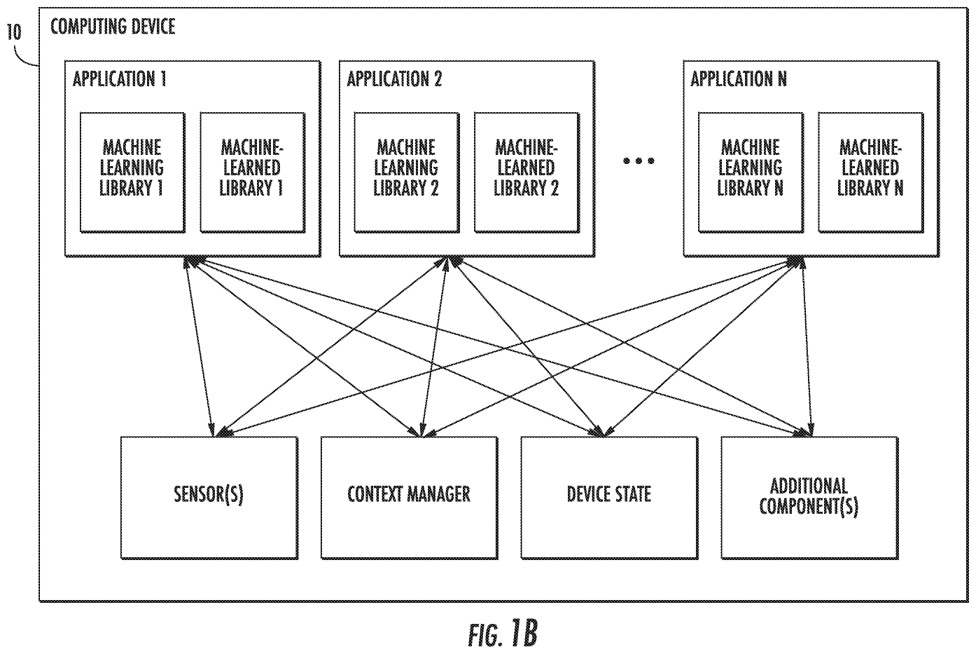

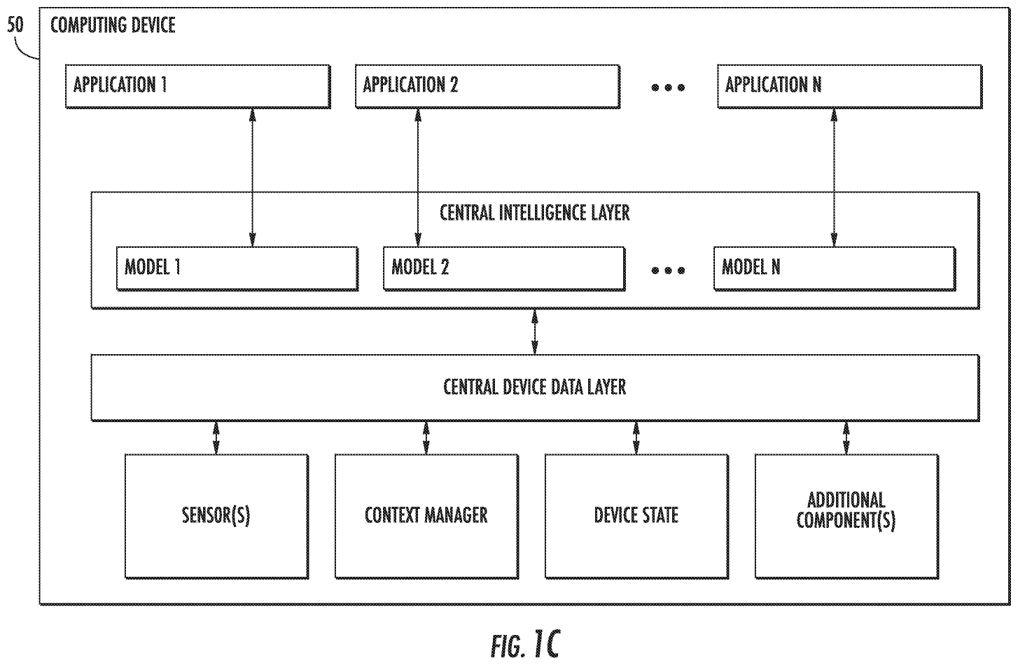

FIG. 1A depicts a block diagram of an example computing system 100 that perform methods for reducing the resource consumption of a convolutional neural network according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

The user computing device 102 can store or include one or more machine-learned models 120. For example, the machine-learned models 120 can be or can otherwise include various machine-learned models that include convolutional neural networks. The neural networks can be or include residual neural networks, deep neural networks, other multi-layer non-linear models, recurrent neural networks (e.g., long short-term memory recurrent neural networks), feed-forward neural networks, or other forms of neural networks.

In some implementations, the one or more machine-learned models 120 can be received from the server computing system 130 over network 180, stored in the user computing device memory 114, and the used or otherwise implemented by the one or more processors 112. In some implementations, the user computing device 102 can implement multiple parallel instances of a single OVERALL model 120 (e.g., to perform parallel operations).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., within a suite of tools and/or applications service for creating or modifying machine-learned models). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can enter a communication.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise includes one or more machine-learned models 140. For example, the models 140 can be or can otherwise include various machine-learned models such as neural networks (e.g., deep recurrent neural networks) or other multi-layer non-linear models.

The server computing system 130 can train the models 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 140 stored at the server computing system 130 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained.

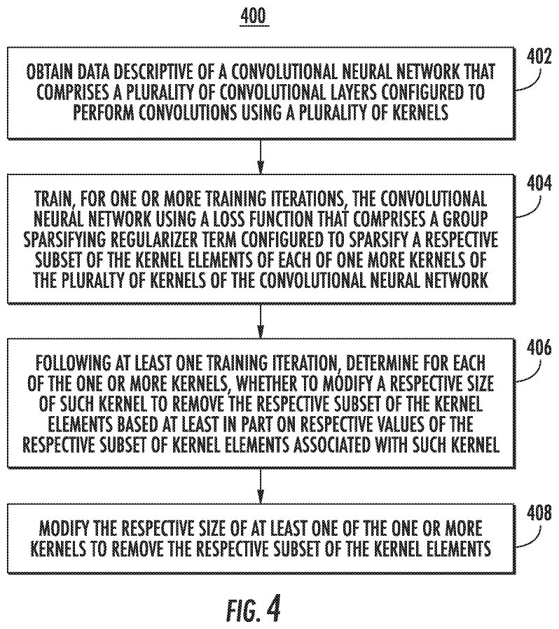

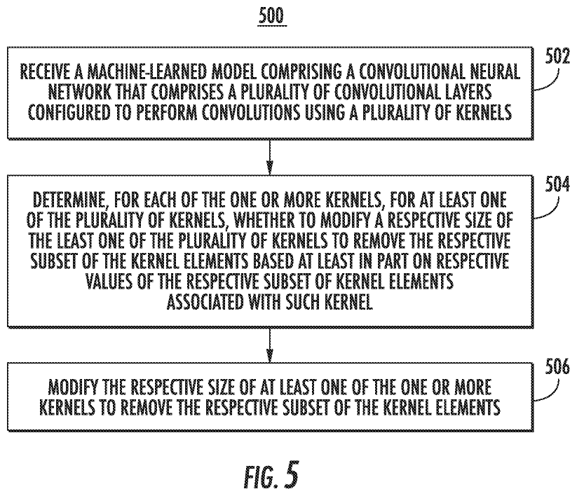

In particular, the model trainer 160 can train a machine-learned model 140 based on a set of training data 142. The training data 142 can include, for example, labeled or unlabeled sets of structured data. As indicated above, “structured data” can refer to any data set for which the data exhibits a particular structure or organization that can be leveraged to analyze the data. Examples of structured data include images, video, sound, text, etc. In some implementations, the model trainer 160 can perform any of the methods described herein to reduce resource consumption of convolutional neural networks, such as, for example, methods 400 and 500 of FIGS. 4 and 5, respectively.

In some implementations, if the user has provided consent, the training examples can be provided by the user computing device 102 (e.g., based on communications previously provided by the user of the user computing device 102). Thus, in such implementations, the model 120 provided to the user computing device 102 can be trained by the training computing system 150 on user-specific communication data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Embodiments

The first section describes modifying an example kernel by removing example subsets of kernel elements. The second section describes application of aspects of the present disclosure to depthwise separable convolutions.

I. Example Kernels and Subsets of Kernel Elements

In some implementations, the size of at least one of the plurality of kernels can be n×n, wherein n is an integer greater than 1 (e.g., 3×3, 5×5, 7×7, etc.). Modifying a given kernel can include reducing the size of the kernel to at least n−1×n−1 (e.g., 4×4, 3×3, 2×2, or 1×1).

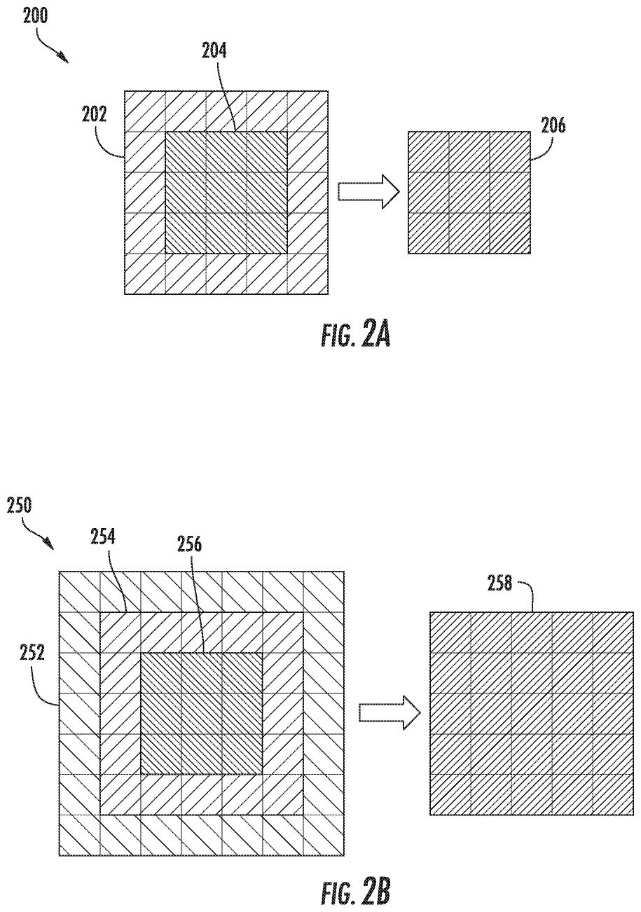

FIG. 2A depicts an example kernel 200 before and after modification to remove a subset 202 of kernel elements according to example embodiments of the present disclosure. The kernel 200 can be modified to remove the subset 202 of the kernel elements. The subset 202 of kernel elements can be arranged around an exterior edge of the kernel 200 (e.g., the outer boundary of kernel elements).

The group sparsifying regularizer term can operate on the subset 202 of kernel elements to sparsify (e.g., regularize to sparsity) the subset 202 of kernel elements. Whether to modify the kernel 200 to remove the subset 202 of kernel elements can be determined based at least in part on respective values of the respective subset 202 of kernel elements. The values of the subset 202 of kernel elements can be compared to values of at least some of the plurality of kernel elements of the kernel 200 that are not included in the respective subset 202 of the kernel elements. For example, a ratio can be computed of a first norm of the values of the subset 202 of the kernel elements to a second norm of the values of an inner set 204 of the kernel elements. The inner set 204 of kernel elements can be defined as kernel elements not contained within the first subset 202 and/or as kernel elements that are not exposed along the exterior edge of the kernel 200.

When the ratio is less than a threshold, the subset 202 of kernel elements can be removed to modify the size of the kernel 200, resulting in a modified kernel 206. The threshold can be selected such that the subset 202 of kernel elements has sufficiently small values and provides a relatively small contribution to the effect of the kernel 200. In other words, the threshold can be selected such that the removing the subset 202 of the kernel 200 does not substantially adversely affect the performance of the convolutional neural network.

FIG. 2B depicts another example kernel 250 before and after modification to remove a subset of kernel elements according to example embodiments of the present disclosure. More specifically, a first subset 252 can be defined along an exterior edge of the kernel 250 (e.g., the outer boundary of kernel elements). A second subset 254 of kernel elements can include kernel elements adjacent the first subset 252 but not exposed along the exterior edge (e.g., a square or ring-shaped set of elements). Thus, concentric rings of kernel elements can be defined as different subsets 252, 254 within the kernel 250. An inner set 256 of kernel elements can be defined as kernel elements not contained within either the first subset 252 of kernel elements or the second subset 254 of kernel elements.

The computing system can be configured to remove one or both of the first and second subsets 252, 254 based on respective values of the kernel elements within each subset 252, 254. A first ratio can be computed of a first norm of the values of the first subset 252 of the kernel elements to an inner norm of the values of the inner subset 256. A first determination can be made whether to remove the first subset 252 of kernel elements. When the first ratio is less than a first threshold, the first subset 252 of kernel elements can be removed to modify the size of the kernel 250.

A second ratio can be computed of a second norm of the values of the second subset 254 of the kernel elements to an inner norm of the values of the inner subset 256. A second determination can be made whether to remove the second subset 252 of kernel elements. When the second ratio is less than a second threshold, the second subset 254 of kernel elements can be removed to modify the size of the kernel 250. The second threshold can be the same as or different than the first threshold.

A single group sparsifying regularizer terms can operate on both the first and second subsets 252, 254 of kernel elements to sparsify (e.g., regularize to sparsity) the kernel elements of the first and second subsets 252, 254. Alternatively, a first group sparsifying regularizer term can operate on the first subset 252, and a second group sparsifying regularizer term can operate on the second subset 254.

The first and second determinations of whether to modify the kernel 250 to remove the first and second subsets 252, 254, respectively, can be made after training of the model is complete. In other words, the model can be trained and then the first subset 252, the second subset 254, or both subsets 252, 254 can be removed.

Alternatively, at least some training iterations can be completed after the first determination and before the second determination. In other words, the first subset 252 can be removed based on the first determination. After subsequent training iterations, if the second ratio becomes less than the second threshold, the second subset 254 can be removed.

In this example, the first subset 252 was removed, but the second subset 254 was not removed, resulting in a modified kernel 258. In this example, the un-modified kernel 250 has a 7×7 size, and the modified kernel 258 has a 5×5 size. It should be understood, however, that more subsets may be defined such that the kernel may be modified to remove more kernel elements. For instance, the resulting modified kernel could be 4×4, 3×3, 2×2, or even 1×1.

In the examples described above with reference to FIGS. 2A and 2B, the subsets 202, 252, 254 of kernel elements on which the group sparsifying regularizer term operates are arranged around an exterior edge of the kernel, forming a border around the kernel. In these examples, the subsets 202, 252, 254 of kernel elements form contiguous shapes (e.g., a border, a square or ring) within the kernel.

In other implementations, the subset(s) of kernel elements can form one or more non-contiguous shapes within a given kernel. For example, the subset of kernel elements can include vertical stripes of elements, horizontal stripes of elements, grids of elements, and/or other arrangements of kernel elements. Thus, at least some of the subset of kernel elements can be dispersed within the kernel (e.g., not limited to kernel elements arranged along the exterior edge of the kernel). Elements within the subset can be adjacent and/or non-adjacent to each other. In some implementations, removal of subsets of kernel elements according to certain arrangements can result in a diluted or “Atruos” kernel. However, the subset of kernel elements can have any suitable shape.

In some implementations, the subset of kernel elements can be selected by or based in part on user input (e.g., a user input that selects the elements along the exterior edge of the kernel). In some implementations, the subset of kernel elements can be randomly selected. In some implementations, the subset of kernel elements can be selected according to their current values (e.g., a certain number or percentage of the kernel elements with the smallest values can be selected for inclusion in the subset of kernel elements that are regularized).

In some implementations, one or more kernels can be modified to increase a dimensional size of the kernel(s) prior to modifying the kernel(s) to remove subset(s) of kernel elements. Some or all kernels of the convolutional neural network can be enlarged (e.g., resized from a 5×5 to a 7×7 kernel). For instance, all kernels can be enlarged (e.g., uniformly or by varying amounts) or only some kernels can be enlarged (e.g., a random selection of layers or kernels can be arbitrarily enlarged). A group sparsifying regularizer term can operate on a subset of kernel elements, as described above, which can result in the kernel being modified to remove the subset (e.g., to “shrink” one or more kernels). The above process of enlarging and shrinking kernels can be repeated such that sizes or configurations of the kernels can be intelligently selected (e.g., to determine optimal sizes or configurations of the kernels and/or improve the configuration of the kernel(s)). Thus, in some implementations, the computing system may be configured to increase the size(s) of one or more kernels, which may improve performance.

In some implementations, the convolutional neural network can include one or more kernels that have multiple depth positions. A first kernel can have a plurality of depth positions and, at least for the first kernel, the group sparsifying regularizer term can be configured to separately sparsify the respective subset of kernel elements at each of the plurality of depth positions. Determining whether to modify the respective size of the first kernel can include separately determining whether to modify the respective size of the first kernel at each of the plurality of depth positions.

In some implementations, the size of the kernel can be modified independently at each depth position. In other words, kernel elements can be removed from a first depth position. Corresponding elements of a second depth position of the kernel may not necessarily be removed. For example, referring to FIG. 2B, at a first depth position, the kernel 250 may be modified to remove the first subset 252 of kernel elements. At a second depth position, the kernel 250 may be modified to remove the first and second subsets 252, 254 of kernel elements. In this example, the kernel 250 may have a 5×5 size at the first depth position and a 3×3 size at the second depth position. In some instances, a resulting kernel can require additional re-structuring into two or more kernels having the same shape and/or size prior to the inference time.

However, in some implementations, the group sparsifying regularizer term can be configured to collectively sparsify the respective subset of kernel elements (at least for one kernel) at each of the plurality of depth positions as a single group. More specifically, subsets of kernel elements can be respectively defined at each depth position. The respective subsets can have the same arrangement and configuration such that, once removed, the modified kernel has a uniform size and/or shape across the plurality of depth positions. For instance, for each depth position of a given kernel, the subset of kernel elements can be defined as the kernel elements that are arranged along the edge of the kernel at each depth position (e.g., forming a boundary of the kernel element). If such subsets are removed, the resulting modified kernel can have a uniform shape across the plurality of depth positions.

II. Depthwise Separable Convolutions

Aspects of the present disclosure can be implemented in conjunction with depthwise separable convolution neural networks. For example, in some implementations, the convolutional neural network can include at least one depthwise separable convolutional layer. At least one kernel of the depthwise separable convolutional layer can be modified as described herein.

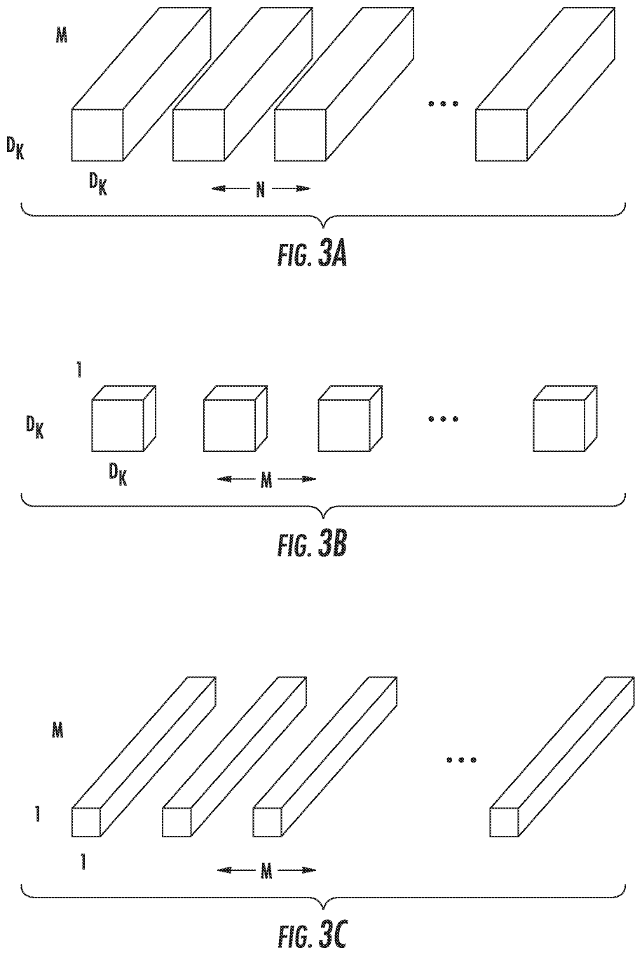

FIGS. 3A through 3C show how a standard convolution (FIG. 3A) can be factorized into a depthwise convolution (FIG. 3B) and a 1×1 pointwise convolution (FIG. 3C). An example standard convolutional layer takes as input a D_{F}×D_{F}×M feature map F and produces a D_{G}×D_{G}×N feature map G where D_{F} is the spatial width and height of a square input feature map, M is the number of input channels (input depth), D_{G} is the spatial width and height of a square output feature map, and N is the number of output channel (output depth). For notational simplicity, it is assumed that the output feature map has the same spatial dimensions as the input and both feature maps are square, however this is not required. The model shrinking results described herein generalize to feature maps with arbitrary sizes and aspect ratios.

The standard convolutional layer can be parameterized by convolution kernel K of size D_{K}×D_{K}×M×N where D_{K} is the spatial dimension of the kernel assumed to be square and M is number of input channels and N is the number of output channels as defined previously.

The output feature map for standard convolution assuming, as examples, stride one and padding is computed as:

$${G}_{k , l , n} = {\sum }_{i , j , m} {K}_{i , j , m , n} \cdot {F}_{k + i - 1 , l + j - 1 , m} \begin{matrix} \\ \end{matrix} \qquad ( 1 )$$

Standard convolutions have the computational cost of:

D_{K}·D_{K}·M·N·D_{F}·D_{F} (1)

where the computational cost depends multiplicatively on the number of input channels M, the number of output channels N the kernel size Dₖ×Dₖ and the feature map size D_{F}×D_{F}.

The standard convolution operation has the effect of filtering features based on the convolutional kernels and combining features in order to produce a new representation. The filtering and combination steps can be split into two steps via the use of factorized convolutions called depthwise separable convolutions for substantial reduction in computational cost.

Depthwise separable convolutions are made up of two layers: depthwise convolutions and pointwise convolutions. Depthwise convolutions can be used to apply a single filter per each input channel (input depth). Pointwise convolution, a simple 1×1 convolution, can then be used to create a linear combination of the output of the depthwise layer.

Depthwise convolution with one filter per input channel (input depth) can be written as:

$${\hat{G}}_{k , l , m} = {\sum }_{i , j} {\hat{K}}_{i , j , m} \cdot {F}_{k + i - 1 , l + j - 1 , m} \qquad ( 3 )$$

where \hat{K} is the depthwise convolutional kernel of size D_{K}×D_{K}×M where the mₜₕ filter in K is applied to the mₜₕ channel in F to produce the mₜₕ channel of the filtered output feature map Ĝ.

Depthwise convolution has a computational cost of:

D_{K}·D_{K}·M·D_{F}·D_{F} (2)

Depthwise convolution is extremely efficient relative to standard convolution. However it only filters input channels, it does not combine them to create new features. So an additional layer that computes a linear combination of the output of depthwise convolution via 1×1 convolution can be used in order to generate these new features.

The combination of depthwise convolution and 1×1 (pointwise) convolution is called depthwise separable convolution.

Depthwise separable convolutions cost:

D_{K}·D_{K}·M·D_{F}·D_{F}+M·N·D_{F}·D_{F} (3)

which is the sum of the depthwise and 1×1 pointwise convolutions.

By expressing convolution as a two step process of filtering and combining a reduction is achieved in computation of:

$$\frac{{D}_{K} \cdot {D}_{K} \cdot M \cdot {D}_{F} \cdot {D}_{F} + M \cdot N \cdot {D}_{F} \cdot {D}_{F}}{{D}_{K} \cdot {D}_{K} \cdot M \cdot N \cdot {D}_{F} \cdot {D}_{F}} = \frac{1}{N} + \frac{1}{{D}_{K}^{2}}$$

For 3×3 sized kernels, depthwise separable convolutions use between 8 to 9 times less computations than standard convolutions at only a small reduction in accuracy.

Referring again to FIG. 3A, aspects of the present disclosure can include modifying kernel elements of a standard convolutional layer. For example, the group sparsifying regularizer term can be configured to collectively sparsify a respective subset of kernel elements (at least for one kernel) at each of a plurality of depth positions (represented by Min FIG. 3A) as a single group. More specifically, subsets of kernel elements can be respectively defined at each depth position. The respective subsets can have the same arrangement and configuration such that, once removed, the modified kernel has a uniform size and/or shape across the plurality of depth positions. For instance, for each depth position of a given kernel, the subset of kernel elements can be defined as the kernel elements that are arranged along the edge of the kernel, for example as described above with reference to FIGS. 2A and 2B, at each depth position. If such subsets are removed, the resulting modified kernel can have a uniform shape across the plurality of depth positions (represented by Min FIG. 3A). In other words, in some implementations the kernels can have a size D_{K}×D_{K} before modification and a size (D_{K}−m)×(D_{K}−m) after modification, where m is an integer greater than 1.

Referring again to FIG. 3B, in some implementations, determining whether to modify the respective size of the first kernel can include separately determining whether to modify the respective size of the first kernel at each of the plurality of depth positions (represented by Min FIG. 3B). The group sparsifying regularizer term can be configured to separately sparsify the respective subset of kernel elements at each of the plurality of depth positions, M. Determining whether to modify the respective size of the first kernel can include separately determining whether to modify the respective size of the first kernel at each of the plurality of depth positions, M. As a result, different kernel elements may be removed at different depth positions. In some instances, the resulting kernel can require additional re-structuring into two or more kernels having the same shape and/or size prior to the inference time.

### Example Methods

FIG. 4 depicts a flow chart diagram of an example computer-implemented method 400 for reducing the resource consumption of a convolutional neural network according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

The method 400 can include, at (402), obtaining, by one or more computing devices, data descriptive of the convolutional neural network. The convolutional neural network can include a plurality of convolutional layers configured to perform convolutions using a plurality of kernels, and each of the plurality of kernels can include a plurality of kernel elements. The data can include information about the structure of the convolutional neural network, such as dimensional sizes of the various layers and/or kernels, and/or connections between the various layers and/or kernels.

The method 400 can include, at (404), training, by the one or more computing devices for one or more training iterations, the convolutional neural network using a loss function that includes a group sparsifying regularizer term. The group sparsifying regularizer term can be configured to sparsify a respective subset of the kernel elements of each of one or more kernels of the plurality of kernels of the convolutional neural network.

The group sparsifying regularizer term can provide a loss penalty that is positively correlated to a magnitude of the values of the subset of kernel elements. As one example, the group sparsifying regularizer term can include a norm of the respective values of the respective subset of kernel elements, such as an L2 norm. The values of the subset of kernel elements can be treated as a one-dimensional vector, and the L2 norm (e.g., group lasso) of the one-dimensional vector can be calculated. Other example norms include an L1 norm and an absolute-value norm. Any suitable norm can be used, however.

As another example, the group sparsifying regularizer term can include a learned scaling parameter (e.g., one respective scaling parameter for each subset of kernel elements). For example, a learned parameter can be scaled by a known function, such as an absolute value, the exponential function, the sigmoid function, etc. The values of the subset of kernel elements can be a function of the resulting learned scaling parameter. As a result, each element of in the subset of kernel elements can have a magnitude that is based in part on the learned scaling parameter. Thus, in one example, each kernel element included in a given subset of kernel elements can have the form ∝ kᵢ, where ∝ is the scaling parameter and kᵢ is a scaled value for the ith element of the subset. The group sparsifying regularizer term can provide a penalty that is based on the magnitude of the scaling parameter ∝. For example, the sparsifying regularizer term can operate on the absolute value of the scaling parameter ∝ or a function of the scaling parameter ∝ such as exp(∝), sigmoid(∝), or the like). In such fashion, the group sparsifying regularizer term can push the magnitude of the scaling parameter ∝ towards zero, thereby also sparsifying the values of the subset of kernel elements which are a function of the scaling parameter ∝.

The computer-implemented method can include, at (406), following at least one training iteration, determining, by the one or more computing devices, for each of the one or more kernels, whether to modify such kernel to remove the respective subset of the kernel elements based at least in part on respective values of the respective subset of kernel elements associated with such kernel. Determining whether to modify the size(s) of the kernel(s) can include comparing the values of the subset of kernel elements to another set of kernel elements (e.g., within the same kernel). More specifically, a ratio can be computed of a first norm of the values of the subset of the kernel elements to a second norm of the values of at least some of the plurality of kernel elements of the respective kernel that are not included in the respective subset of the kernel elements. When the ratio is less than a threshold, the subset of kernel elements can be removed to modify the size of the kernel. The threshold can be selected such that the subset of kernel elements has sufficiently small values and provides a relatively small contribution to the effect of the kernel. In other words, the threshold can be selected such that the removing the subset of the kernels does not substantially adversely affect the performance of the convolutional neural network.

The computer-implemented method can include, at (408), modifying, by the one or more computing devices, at least one of the one or more kernels to remove the respective subset of the kernel elements, for example as described above with reference to FIGS. 2A through 3C.

FIG. 5 depicts a flow chart diagram of an example method 500 for reducing the resource consumption of a convolutional neural network according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

The computer-implemented method 500 for reducing the resource consumption of a convolutional neural network can include, at (502), receiving a machine-learned model that includes a convolutional neural network. The convolutional neural network can include a plurality of convolutional layers configured to perform convolutions using a plurality of kernels. Each of the plurality of kernels can include a plurality of kernel elements.

As one example, a user can provide a machine-learned model for modification as part of a service offered as a part of a suite of tools and/or applications for building and/or modifying machine-learned models. The user can upload the machine-learned model to a computing system, for example, through a web-based interface and/or application program interface. Alternatively, the users can start with pre-existing machine-learned models stored by the computing system. The users can control or direct training or modification of the machine-learned model as described herein. The users can modify one or more control parameters (e.g., a threshold ratio of norm values) or otherwise control aspects of the systems and methods described herein. The users can define and/or modify the subset of kernel elements, the group sparsifying regularizer term, or other aspects of the system and methods.

The computer-implemented method 500 can include, at (504), determining, by the one or more computing devices, for at least one of the plurality of kernels, whether to modify a respective size of the at least one of the plurality of kernels to remove the respective subset of the kernel elements based at least in part on respective values of the respective subset of kernel elements associated with such kernel as described herein, for example with reference to FIGS. 2A, 2B, and 4).

The computer-implemented method 500 can include, at (506), modifying, by the one or more computing devices, the respective size of at least one of the one or more kernels to remove the respective subset of the kernel elements as described herein, for example with reference to FIGS. 2A through 3C.

Thus, in at least some implementations, modification of the convolutional neural network can be performed after training of the model has been completed. In other words, at least some aspects of the present disclosure do not involve or require performing any training of the machine-learned model.

### Example Experiments and Results

Experiments were conducted including modifying various machine-learned models according to aspects of the present disclosure. The machine-learned models were analyzed before and after modification.

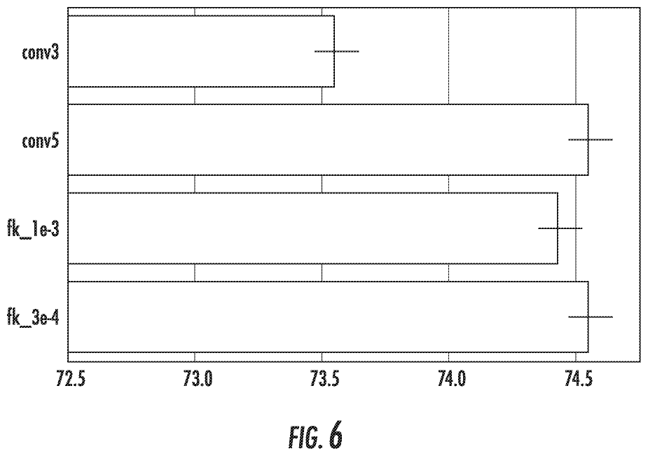

FIG. 6 is a chart of accuracy measurements for four image-recognition machine-learned models: a model including 3×3 convolutions, a model including 5×5 convolutions, and two models that were trained and modified according to aspects of the present disclosure using different regularization strengths, as described below. More specifically, a Resent_v1_50 model, which includes 3×3 convolutions, was selected as a starting point. A 5×5 Renset_v1_50 model was created in which all convolutions were resized to be 5×5 convolutions. Two versions of the 5×5 Renset_v1_50 model were then separately modified and trained according to aspects of the present disclosure using respective loss functions that include respective group sparsifying regularizer terms. The group sparsifying regularizer terms included different regularization strength parameters resulting in different levels of regularization.

First, subsets of the kernel elements were defined for each kernel. More specifically, the subsets of kernel elements were defined as the elements arranged around respective exterior edges of each kernel, as described above with reference to the subset 202 of FIG. 2A.

Next, the models were trained using a publicly available image database known as “ImageNet,” available at www.image-net.org. During training of each model, the group sparsifying regularizer term operated on the subsets of kernel elements to sparsify (e.g., regularize to sparsity) the subsets of kernel elements.

After training, a ratio of an L2 norm of the kernel elements of the subset to an L2 norm of an inner set of kernel elements was calculated for each kernel. Kernels containing subsets that had ratios less than a threshold value were modified to remove the subset of kernel elements such that 5×5 kernels became 3×3 kernels.

The above procedure was repeated for two instances of the 5×5 Renset_v1_50 model using two different regularization strength parameters: 1e-3 and 3e-4. More specifically, the group sparsifying regularizer term included the L2 norm of the subset of kernel elements multiplied by the regularization strength parameter to control its relative effect. Thus, a larger regularization strength resulted in a larger loss penalty for the subset of kernel elements.

The resulting models are referred to as “fk_1e-3” and “fk_3e-4” respectively. The original 3×3 Renset_v1_50 model and the 5×5 Renset_v1_50 model were also trained with a loss function that did not include a group sparsifying regularizer term, and no kernels were modified or re-sized.

FIG. 6 shows the accuracy percentages for each of the four models. The four resulting models were tested across six runs and respective accuracy percentages were calculated. The accuracy results for the 3×3 Renset_v1_50 and 5×5 Renset_v1_50 are labeled “conv3” and “conv5,” respectively. As shown in FIG. 6, the fk_1e-3 model exhibits minimal reduction in accuracy compared with the conv5 model and performs substantially better than the conv3 model. The fk_3e-4 model performs comparably with the conv5 model. Error bars are shown based on the six runs for each model. Although not quantified here, it is believed that aspects of the present disclosure may increase accuracy of the resulting model by reducing overfitting.

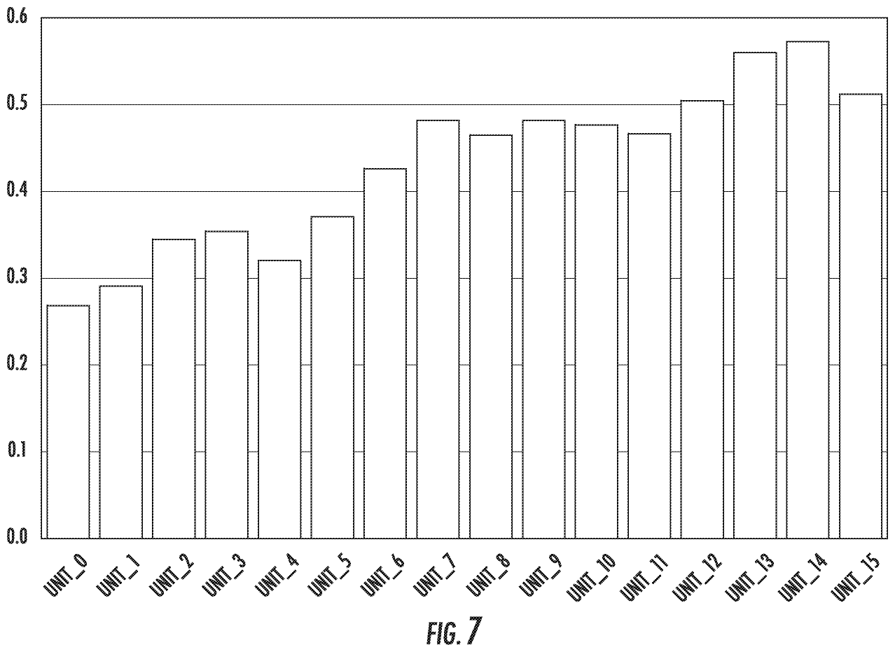

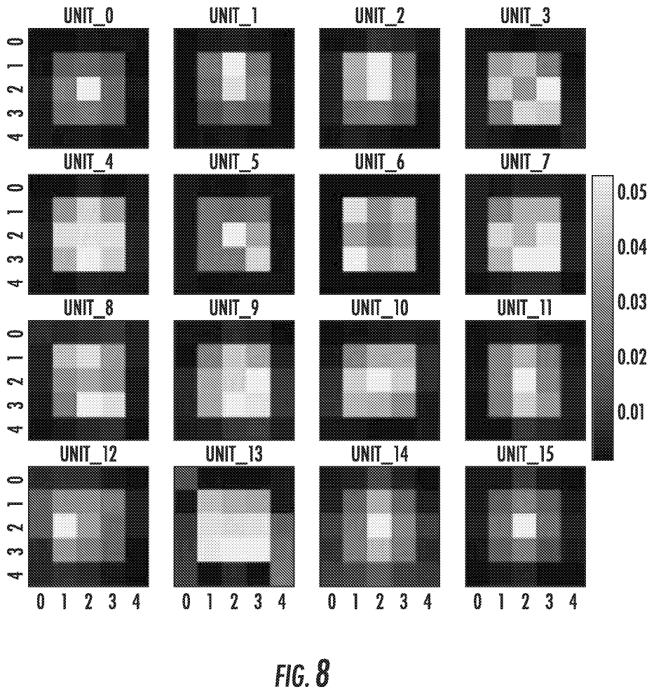

FIG. 7 illustrates average ratios of the L2 norms for the fk_1e-3 model. More specifically, an average of the L2 norms for a first channel of each kernel of respective layers of the model was calculated. The fk_1e-3 model includes 16 convolutional layers arranged between respective input and outputs from a first convolutional layer (labeled “unit_0”) arranged near the input to a last convolutional layer (“unit_15”) arranged near the output. Lower ratio values indicate smaller values for the subsets of kernels elements. Thus, kernels having lower ratio values are more likely to be modified to remove the subset of kernel elements. As illustrated in FIG. 7, the average ratios for convolutional layers near the input of the model were lower than those near the output of the model. More specifically, convolutional layers near the input contain kernels including subsets of kernel elements that were more aggressively regularized.

FIG. 8 depicts a “heatmap” of an average of kernel element values over an absolute value of the input depth for select kernels within sequential layers of the fk_1e-3 model. As shown in FIG. 8, convolutional layers near the input of the model were more strongly regularized than those near the output. More specifically, the kernel element values of the subsets of layers unit_0 through unit_11 were regularized to sparsity and subsequently removed, resulting in 3×3 kernels. However, the kernel element values of the subsets of unit_12 through unit_15 were non-trivial, and as a result such subsets were not removed. Rather, the kernels of convolutional layers unit_12 through unit_15 remained 5×5 kernels.

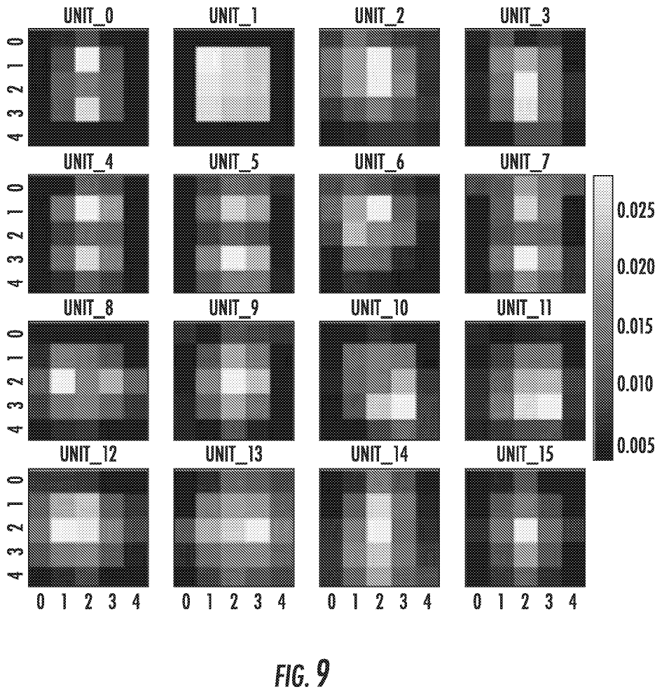

FIG. 9 depicts a “heatmap” of an average of kernel element values over an absolute value of the input depth for select kernels within sequential layers of the fk_3e-4 model. As expected, the regularization was less aggressive because of a lower regularization strength parameter. As a result, more values of the subsets of edge kernel elements remained non-trivial, and thus fewer kernels were converted into 3×3 kernels, and more kernels remained 5×5 kernels.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for reducing the resource consumption of a convolutional neural network, the method comprising:
obtaining, by one or more computing devices, data descriptive of the convolutional neural network, wherein the convolutional neural network comprises a plurality of convolutional layers configured to perform convolutions using a plurality of kernels, each of the plurality of kernels comprising a plurality of kernel elements;
training, by the one or more computing devices for one or more training iterations, the convolutional neural network using a loss function that comprises a group sparsifying regularizer term configured to sparsify a respective subset of the kernel elements of each of one or more kernels of the plurality of kernels of the convolutional neural network;
following at least one training iteration, determining, by the one or more computing devices, for each of the one or more kernels, whether to modify such kernel to remove the respective subset of the kernel elements based at least in part on respective values of the respective subset of kernel elements associated with such kernel; and
modifying, by the one or more computing devices, at least one of the one or more kernels to remove the respective subset of the kernel elements.

2. The computer-implemented method of claim 1, wherein the group sparsifying regularizer term provides, for each respective subset of kernel elements, a loss penalty that is positively correlated to a magnitude of the values of the subset of kernel elements.

3. The computer-implemented method of claim 1, wherein the group sparsifying regularizer term provides a loss penalty that is not correlated to the magnitude of the values of the kernel elements that are not included in subset of kernel elements.

4. The computer-implemented method of claim 1, wherein, for each of the one or more kernels, the group sparsifying regularizer term comprises a norm of the respective values of the respective subset of kernel elements.

5. The computer-implemented method of claim 1, wherein, for each of the one or more kernels, the group sparsifying regularizer term comprises an L2 norm of the respective values of the respective subset of kernel elements.

6. The computer-implemented method of claim 1, wherein the group sparsifying regularizer term comprises a learned scaling parameter.

7. The computer-implemented method of claim 6, wherein each element of each respective subset of kernel elements has a magnitude that is based in part on the learned scaling parameter.

8. The computer-implemented method of claim 1, wherein determining, by the one or more computing devices, for each of the one or more kernels, whether to modify such kernel to remove the respective subset of the kernel elements comprises, for each of the one or more kernels:
determining, by the one or more computing devices, for each of the one or more kernels, to modify such kernel to remove the respective subset of kernel elements when a ratio of a first norm of the values of the respective subset of the kernel elements to a second norm of the values of at least some of the plurality of kernel elements of such kernel that are not included in the respective subset of the kernel elements is less than a threshold.

9. The computer-implemented method of claim 1, wherein, for at least one of the one or more kernels, the respective subset of kernel elements comprises elements arranged around an exterior edge of the kernel.

10. The computer-implemented method of claim 1, wherein a size of at least one of the plurality of kernels is n×n, wherein n is an integer greater than 1, and wherein modifying, by the one or more computing devices, at least one of the one or more kernels comprises reducing, by the one or more computing devices, the size of the at least one of the one or more kernels to at least n−1×n−1.

11. The computer-implemented method of claim 1, wherein the group sparsifying regularizer term is configured to separately sparsify at least two different subsets of the kernel elements of a same kernel of the one or more kernels.

12. The computer-implemented method of claim 1, wherein:
at least a first kernel of the one or more kernels has a plurality of depth positions and, at least for the first kernel, the group sparsifying regularizer term is configured to separately sparsify the respective subset of kernel elements at each of the plurality of depth positions; and
determining, by the one or more computing devices, whether to modify the first kernel comprises separately determining, by the one or more computing devices, whether to modify the first kernel at each of the plurality of depth positions.

13. The computer-implemented method of claim 1, wherein:
at least a first kernel of the one or more kernels has a plurality of depth positions; and
determining, by the one or more computing devices, whether to modify the first kernel comprises determining, by the one or more computing devices, whether to uniformly modify the first kernel across all of the plurality of depth positions.

14. The computer-implemented method of claim 13, wherein, at least for the first kernel, the group sparsifying regularizer term is configured to collectively sparsify the respective subset of kernel elements at each of the plurality of depth positions as a single group.

15. The computer-implemented method of claim 1, wherein at least one of the one or more kernels is included in a depthwise separable convolutional layer of the convolutional neural network.

16. The computer-implemented method of claim 1, wherein modifying, by the one or more computing devices, at least one of the one or more kernels to remove the respective subset of the kernel elements comprises modifying, by the one or more computing devices, a respective size of at least one of the one or more kernels to remove the respective subset of the kernel elements.

17. A computing system comprising:
one or more processors;
a machine-learned model comprising a convolutional neural network, the convolutional neural network comprising a plurality of convolutional layers comprising a plurality of kernels, the machine-learned model being configured to receive a model input, and, in response to receipt of the model input, output a model output;
one or more non-transitory computer-readable media that collectively store instructions that, when executed by the one or more processors, cause the computing system to perform operations, the operations comprising:
obtaining data descriptive of the convolutional neural network, wherein the convolutional neural network comprises a plurality of convolutional layers configured to perform convolutions using a plurality of kernels, each of the plurality of kernels comprising a plurality of kernel elements;
training, for one or more training iterations, the convolutional neural network using a loss function that comprises a group sparsifying regularizer term configured to sparsify a respective subset of the kernel elements of each of one or more kernels of the plurality of kernels of the convolutional neural network;
following at least one training iteration, determining for each of the one or more kernels, whether to modify a respective size of such kernel to remove the respective subset of the kernel elements based at least in part on respective values of the respective subset of kernel elements associated with such kernel; and
modifying the respective size of at least one of the one or more kernels to remove the respective subset of the kernel elements.

18. The computing system of claim 17, wherein the group sparsifying regularizer comprises at least one of a norm of the respective values of the predefined subset of kernel elements, a learned parameter or a scale comprising the learned parameter.

19. The computing system of claim 17, wherein determining, by the one or more computing devices, for each of the one or more kernels, whether to modify the respective size of such kernel to remove the respective subset of the kernel elements comprises, for each of the one or more kernels:
determining, by the one or more computing devices, to modify the respective subset of the at least one or more kernels to remove the respective subset of kernel elements when a ratio of a first norm of the values of the respective subset of the kernel elements to a second norm of the values of at least some of the plurality of kernel elements of such kernel that are not included in the respective subset of the kernel elements is less than a threshold.

20. A computing system comprising:
one or more processors;
one or more non-transitory computer-readable media that collectively store instructions that, when executed by the one or more processors, cause the computing system to perform operations, the operations comprising:
receiving a machine-learned model comprising a convolutional neural network, wherein the convolutional neural network comprises a plurality of convolutional layers configured to perform convolutions using a plurality of kernels, each of the plurality of kernels comprising a plurality of kernel elements;
determining, by the one or more computing devices, for at least one of the plurality of kernels, whether to modify a respective size of the at least one of the plurality of kernels to remove the respective subset of the kernel elements based at least in part on respective values of the respective subset of kernel elements associated with such kernel; and
modifying, by the one or more computing devices, the respective size of at least one of the one or more kernels to remove the respective subset of the kernel elements.

21. (canceled)

22. (canceled)
